(19) United States
(12) Patent Application Publication
(10) Pub. No.: US 2004/0101226 A1
(43) Pub. Date: May 27, 2004

(54) Magnet isolator with integrated focusing apparatus

(76) Inventor: Eric Zbinden, Mountain View, CA (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/306,486

(22) Filed: Nov. 26, 2002

(51) Int. Cl. G02B 6/00

(52) U.S. Cl. 385/11

(57) ABSTRACT

An optical isolator which includes a magnet, at least one polarizer, and a plurality of optical elements. The magnet has front and back surfaces. The polarizer is coupled to the magnet to process an input light beam. The optical elements are coupled to the front and back surfaces of the magnet at some distance away from the polarizer so that reflection from the polarizer does not focus back to the optical elements.

### BACKGROUND OF THE INVENTION

The present invention relates to a magnet isolator with integrated focusing apparatus. More particularly, the present invention relates to the use of a magnet as a support for both focusing elements and an optical isolator.

An optical isolator is a device that operates to prevent a laser beam reflecting on an optical fiber face to a semiconductor light source. Furthermore, the isolator uses a magnetic field generated by a magnet, and is usually composed of a birefringent material, such as a Faraday element, disposed between two polarizers. A magnetic field oriented along the optical axis may be provided by a permanent magnet.

FIG. 1 shows an exploded view of a simplified optical isolator to explain a typical operation. The simplified optical isolator may include a pair of polarizers 106 and 110 and a Faraday element 108. A beam of light with a linear polarization that is parallel to the input polarizer will be transmitted through the input polarizer. The polarization is then rotated by 45° through the faraday rotator to end up aligned with the output polarizer and transmitted through. From the opposite direction, a beam of light with a linear polarization parallel with the output polarizer is transmitted through the output polarizer while all other polarization is absorbed. The transmitted light has its polarization rotated 45° by the faraday rotator and hit the input polarizer with a 90° offset between the light and polarize polarization directs effectively blocking the light.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 shows an exploded view of a conventional simplified optical isolator.

FIGS. 2A through 2E illustrate optical isolators in accordance with five different embodiments of the invention.

FIGS. 3A through 3G illustrate integrated optical assemblies utilizing the above-described optical isolators in accordance with embodiments of the invention.

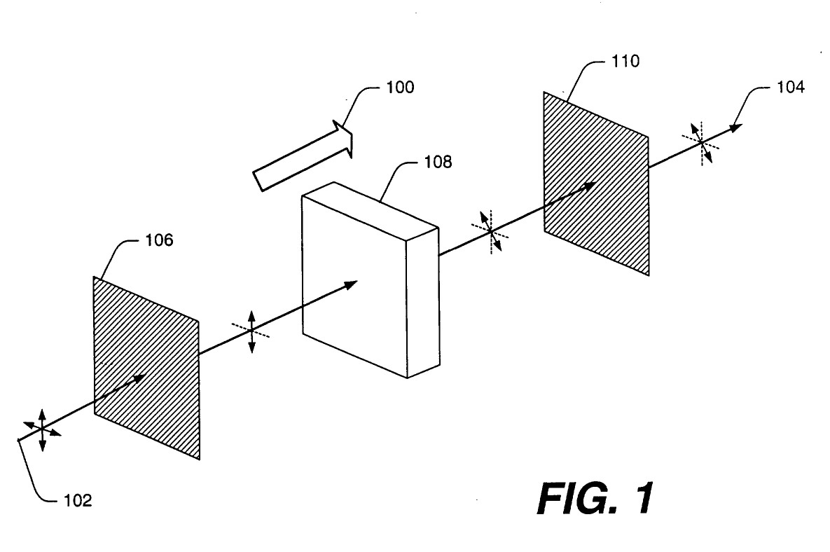

### DETAILED DESCRIPTION OF THE PRESENT INVENTION

In recognition of the above-stated difficulties associated with an optical isolator assembly, embodiments for a magnet isolator with integrated focusing apparatus are described. An optical isolator chip, or device, is an optical device that exhibits a different insertion loss for two beams traveling the same path in opposite directions when subjected to a magnetic field.

Consequently, for purposes of illustration and not for purposes of limitation, the exemplary embodiments of the invention are described in a manner consistent with such use, though clearly the invention is not so limited.

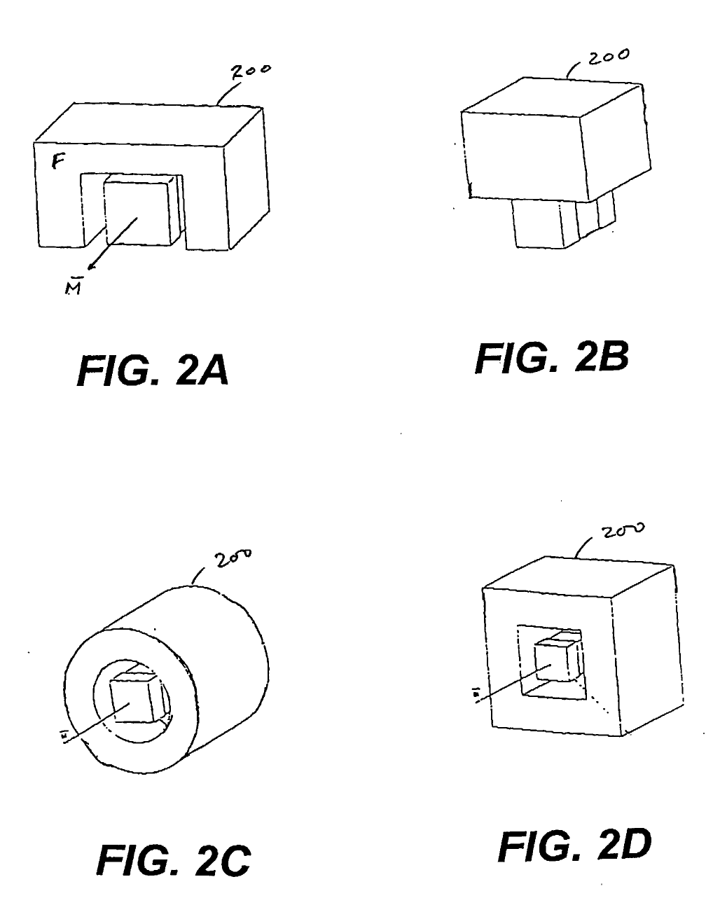

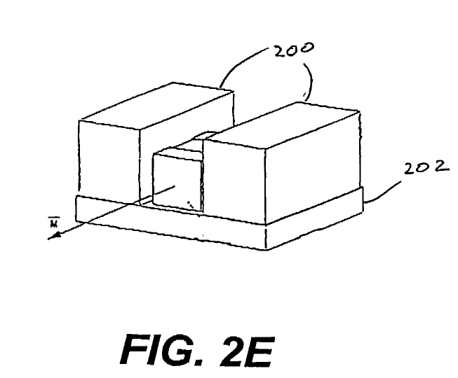

FIGS. 2A through 2E illustrate optical isolators in accordance with five different embodiments of the invention. In the illustrated embodiments, each magnet 200 has a front (F) surface and a back (not shown) surface about normal to the optical axis (M). The shape of the magnet 200 may be, but not limited to square (FIG. 2B), rectangular (FIG. 2A), U-shaped (FIG. 2E), O-shaped (FIG. 2C), and/or composed of multiple parts. The embodiment of FIG. 2E also includes a support structure 202.

In a further embodiment, each optical isolator illustrated in FIGS. 2A through 2E may be used in an optical module in conjunction with a light source and a light receiver. The light source is usually a laser diode, a light-emitting diode (LED) or a light output of a waveguide such as a fiber, electro-absorption (EA) device, or planar waveguide. The light receiver may be a waveguide (e.g., fiber, EA, etc.) or a photodiode.

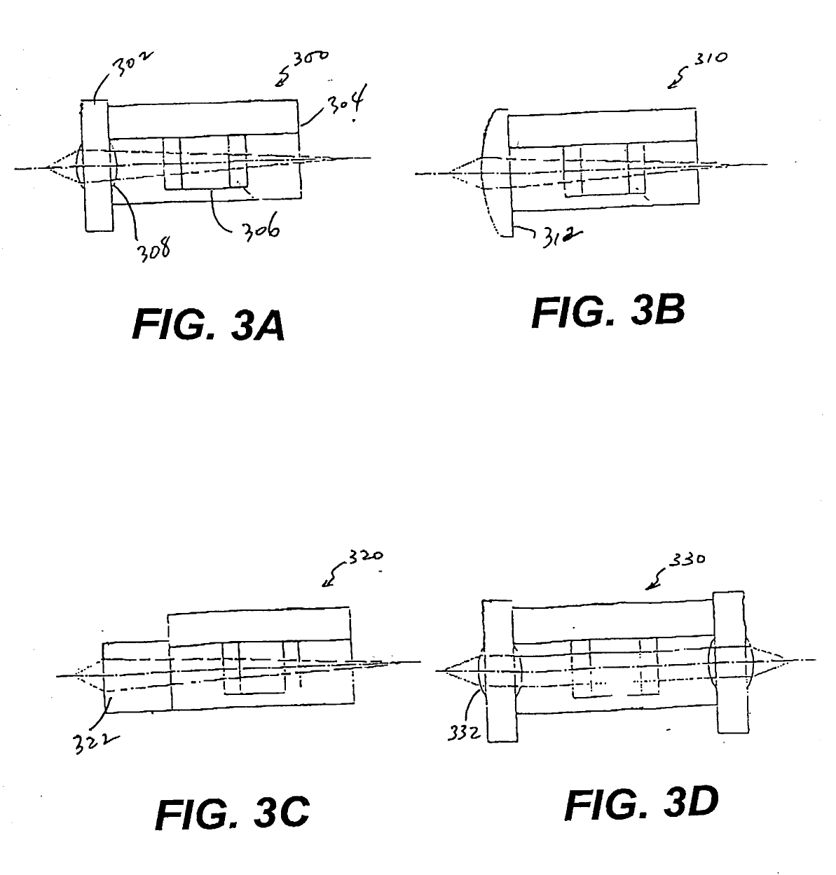

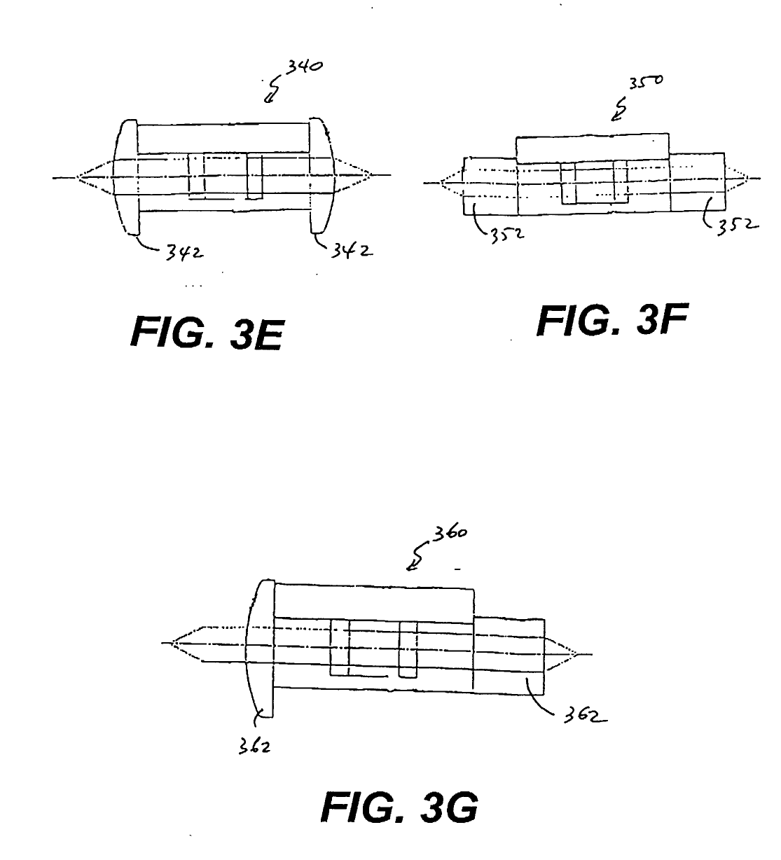

FIGS. 3A through 3G illustrate integrated optical assemblies 300-360 utilizing the above-described optical isolators in accordance with embodiments of the invention. For each embodiment, the front and/or back surface(s) is (are) used as attachment surface(s) for collimating optics. The length of the magnet 304 or the support structure 304 or 202 and the position of the garnet-polarizer assembly 306 within the magnet 304 are designed in such a way that the structure and the assembly 300-360 match the optical distance needed by the focusing element(s) 302-362, the light source and the light receiver, and possibly the magnet isolator. The focusing element(s) 302-362 may be attached using epoxy. However, if the lens is plated, a solder-based attachment technique may also be used.

The geometries shown in the illustrated embodiments, where the beam is not focused through the optics of the isolator, provide an advantage over other conventional geometries. The advantage is provided when the reflection from the polarizers does not focus back at the same location as the light source/light receiver. Moreover, this advantage further provides other benefits including promoting decreased number of parts in the assembly and the number of assembly steps, enabling decreased overall size of the optical element, facilitating the optical element handling, and allowing the optics to be self-contained so that the assembly (lens and optical isolator) may be assembled by the supplier.

There has been disclosed herein embodiments for a magnet isolator with integrated focusing apparatus. The length of the magnet or the support structure 304 and the position of the garnet-polarizer assembly within the structure are designed in such a way that the structure and the assembly match the optical distance needed by the focusing element(s), the light source and the light receiver.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. In other instances, well-known structures and functions were not described in elaborate detail in order to avoid obscuring the subject matter of the present invention. Accordingly, the scope and spirit of the invention should be judged in terms of the claims which follow.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. An apparatus, comprising:
a magnet having front and back surfaces;
one optical isolator device coupled to the magnet to process an input light beam; and
a plurality of optical elements coupled to the front and back surfaces of the magnet.

2. The apparatus of claim 1 wherein the plurality of optical elements placed a distance away from the optical isolator chip so that reflection from the optical isolator device does not focus back to the input light beam focus point.

3. The apparatus of claim 2, wherein the plurality of optical elements comprises a lens.

4. The apparatus of claim 2, wherein the plurality of optical elements comprises a lens coupling a first waveguide to a second waveguide.

5. The isolator of claim 2, wherein the plurality of optical elements comprises a bus coupling a laser diode to a waveguide.

6. The apparatus of claim 2, wherein the plurality of optical elements comprises two lenses, one mounted in the front surface, one mounted in the back surface.

7. The apparatus of claim 2, wherein the plurality of optical elements comprises two lenses, one mounted in the front surface, one mounted in the back surface coupling a waveguide to another waveguide.

8. The apparatus of claim 2, wherein the plurality of optical elements comprise two lenses of which one is mounted in the front surface, and one is mounted in the back surface coupling a layer diode to a waveguide.

9. The apparatus of claim 1, wherein the plurality of optical elements includes a light receiver.

10. The apparatus of claim 8, wherein the light receiver includes a waveguide.

11. The apparatus of claim 9, wherein the waveguide includes a fiber optic cable.

12. The apparatus of claim 1, wherein the magnet is a permanent magnet.

13. A method comprising:
receiving an input light beam;
providing a magnet having front and back surfaces;
coupling an optical isolator device to the magnet to process the input light beam; and
coupling a plurality of optical elements to the front and back surfaces of the magnet.

14. The method of claim 13 wherein the plurality of optical elements are coupled a first distance away from the optical isolator device so that reflection from the optical isolator device does not focus back to the input light beam focus point.

15. The method of claim 13, wherein the coupling a plurality of optical elements includes attaching the elements using epoxy.

16. The method of claim 13, wherein the coupling a plurality of optical elements includes attaching the elements using a solder-based attachment technique.

17. The method of claim 13, wherein the coupling of a plurality of optical elements includes attaching the elements using a welding process.

18. A method comprising:
receiving an input light beam;
providing a magnet having front and back surfaces;
coupling an optical isolator device to the magnet to process the input light beam; and
coupling a plurality of optical elements to the front and back surfaces of the magnet, wherein the plurality of optical elements are coupled a first distance away from the optical isolator device so that reflection from the optical isolator device does not focus back to the input light beam focus point, and wherein the coupling a plurality of optical elements includes attaching the elements using epoxy.

19. The method of claim 18, wherein the waveguide includes a fiber optic cable.

20. The method of claim 18, wherein the coupling of a plurality of optical elements includes attaching the elements using a welding process.
